(19) United States
(12) Patent Application Publication
(10) Pub. No.: US 2016/0217699 A1
(43) Pub. Date: Jul. 28, 2016

(54) AR-BOOK

(71) Applicant: Suresh T. THANKAVEL, Brookfield, WI (US)

(72) Inventor: Suresh T. Thankavel, Brookfield, WI (US)

(21) Appl. No.: 14/916,060

(22) PCT Filed: Sep. 2, 2014
(86) PCT No.: PCT/US14/53686

§ 371 Date: Mar. 2, 2016

Related U.S. Application Data
(60) Provisional application No. 61/872,801, filed on Sep. 2, 2013.

(51) Int. Cl. G09B 5/06; G06F 3/0483

(52) U.S. Cl. CPC G09B 5/06; G06F 3/0483

(57) ABSTRACT

The present invention illustrates a picture book augmented reality application that includes scanning capability, 3D graphics presentation and video presentation that immerses participants into the story line of a picture book. The book cover or a page in the book itself can be scanned with a smart device (smart phone, tablet, Kindle, Nuke, MAC, PC, laptop), which activates the augmented reality book application to get the appropriate content of the AR-Book. The participant can see the visual world of themselves being part of the story line through an avatar when displaying the video/2D/3D content using the AR application. Therefore, the invention allows participants to be immersed into the picture book as one of the characters in the picture book using their real face or a caricature of their face wrapped/attached to the selected character (avatar) in the picture book.

### BACKGROUND OF THE INVENTION

1. Field of the Invention

The object of the present invention is to provide a picture book augmented reality application that includes scanning capability, 3-Dimensional graphics presentation and video presentation that immerses participants into the story line of a picture book.

2. Discussion of the Prior Art

Augmented reality (AR) is a live direct or indirect view of a physical, real-world environment whose elements are augmented (or supplemented) by computer-generated sensory input such as sound, video, graphics or GPS data. See, for example, Wikipedia entries for Augmented Reality. Several examples of Augmented Reality applications include Layar, Wikitude, Yelp Monocle, Google Ingress, and SpecTrec. See http://www.digitaltrends.com/mobile/best-augmented-reality-apps/#!bOr8jv. Sony Playstation's Wonderbook placing a camera in a hardback alongside a Move control wand enabled users to interact audio/visually, for example with Harry Potter's Book of Spells which was sold as a companion. iDinosaur is another commercial example of an AR book, which allows children to bring dinosaurs to life and explore the subject more interactively. Princess And Her Pals 3-D is another example of an AR book, where ordinary pages are brought to life with animated characters and environments, utilizing a smartphone to interact with the book. Carlton Books Kids released an AR book of Disney's Monsters Inc. inviting users to utilize the webcam on their PC to explore Monstropolis. Interactive books and mixed reality toys are finding an extended market owing to the proliferation of smartphones in the market.

U.S. Pat. No. 8,223,196 titled Projector systems and methods for producing digitally augmented, interactive cakes and other food products discloses a method to augment a food product with media including video images to enable story telling. This patent granted to Disney claims a method and system to enhance 3D projection surfaces on food items to enable the user to interact with food and track a user's experience with the help depth-sensing algorithms.

US Patent Publication No. 20130187950 titled Transparent device for mobile device discloses the coupling of a projection display with a mobile device, wherein the device generates light at a holographic element, providing a display to the user operating the mobile device. In this invention, AR applications are enabled at a device level, however the introduction of novel avatars, 3D projections and a modular approach to enable AR in a storybook is novel to the present invention.

US Patent Publication No. 20130044042 titled Wearable device with input and output structures discloses a pair of glasses onto which multiple streams of information can be displayed to a user wearing them, depending on an initial configuration, commercially called Google Glass. The present invention enables a picture book augmented reality application, which can feed into the on-board computing system described in connection with reference numeral 118 in US Patent Publication No. 20130044042.

US Patent Publication No. 20120122570 titled Augmented Reality gaming experience describes a multi-player story-based game where the gaming and story are tied to a smart phone, cell phone, and/or wireless device. The said devices provide the gamer with video, voice, text and audio facilities along with other facilities to enrich the gamer's interaction with the environment. This is not limited to other gamers, real world actors, conversion of a person, place, and/or thing into a game component via augmented reality technology.

Japanese Patent No. JP 2011253512 A titled Application device of augmented reality describes a device that synthesizes each type of picture book with different electronic information. The electronic information of the picture book can be produced in camera, binoculars, telescope, magnifiers, microscope, etc., where the augmented reality is introduced. This reduces the need of the user to see the picture book in every observation. This does not say anything about the computer or smart phone application as discussed in the present invention.

### SUMMARY OF THE INVENTION

The present invention, AR-Book, is the embodiment of an augmented reality book application that immerses participants (readers of the book), while viewing an actual physical AR-Book, picture book or viewing a picture book via the AR application. The pictures come alive in the form of videos or 3D figures displayed on top of the picture, creating an illusion of images becoming alive (augmenting videos and 3D objects on top of the image/ picture) when viewed through the mobile application. In the invention, the subject (reader or that is configured) becomes part of the story line character. The participant's own images become part of the story (video or 3D) along with the other story line characters while displaying the AR content.

The present invention has different control mean: (a) a scanner to scan a graphics pattern to activate and use the picture book application, using commercially available devices (smart phone, tablet, PC, laptop); (b) an input device to use a commercial smart device (smart phone, tablet, PC, laptop) to take a picture of participants' faces, select a caricature of the participants' faces or use actual faces of participants and select an avatar to use with participants' faces or caricatures of participants' faces and to interact with the AR-Book application; (c) a computer to generate 3D graphics or a video that immerses participants into the picture book story line; and (d) an interface to display the video and/or graphics in response to the participants' picture book and a computer.

Therefore, the present AR-Book augmented reality application invention can be used on commercial smart devices (smart phone, tablet, Kindle, Nuke, MAC, PC, laptop) and for 3D graphics and video. The present application provides an advantage to handle different languages. The present application also is useful for any comic book, single poster printed image, live image (face), which can be replaced with a configurable face once the user selects the character. This is also applicable to any poster that has a face, which can be replaced with the live face of the user who is viewing through this application. The face appears live, that is, the user's lips and movements reflect on the poster's face. The video or 3D interactive animated objects appear on the page in the form of a short clip played in that page only. This applies to an independent page, which has Augmented Reality application and every page may or may not have Augmented Reality application, and these such pages are decided when the AR Book is designed. When the user activates the video mode, it is supported by audio to play in real-time and the user interactions including hand, facial, and eye movements are interactive with the audio.

These features, and other features and advantages of the present invention will become more apparent to those of ordinary skill in the relevant art when the following detailed description of the preferred embodiments is read in conjunction with the appended drawings in which like reference numerals represent like components throughout the several views.

### BRIEF DESCRIPTION OF THE DRAWINGS

FIG. 1 (a and b) shows a perspective view of the picture book, either actual or within a website.

FIG. 2 (a and b) shows a first perspective view of the AR-Book application to welcome a visitor.

FIG. 3 (a and b) shows a second perspective view of the AR-Book application entering text for each participant's name.

FIG. 4 (a and b) shows a third perspective view of the AR-Book application displaying the face silhouette.

FIG. 5 (a and b) shows a fourth perspective view of the AR-Book application displaying the participants face into the silhouette.

FIG. 6 shows a fifth perspective view of the AR-Book application, which saves the participant's face into the AR-Book application.

FIG. 7 shows a sixth perspective view of the AR-Book application displaying the participant's caricature face onto the silhouette.

FIG. 8 shows a seventh perspective view of the AR-Book application, which saves the participant's caricature face into the AR-Book application/ database.

FIG. 9 shows an eighth perspective view of the AR-Book application to enter text for the user by selecting either the participant's caricature face or the participant's real face.

FIG. 10 shows a ninth perspective view of the AR-Book application for the user to select the desired selections for each participant.

FIG. 11 (a and b) shows a tenth perspective view of the AR-Book application, which displays avatars and asks the user to select an avatar for each participant.

FIG. 12 shows an eleventh perspective view of the AR-Book application, which facilitates the user to select the desired avatar for each participant.

FIG. 13 (a and b) shows a twelfth perspective view of the AR-Book application wherein the participant's facial image (either real or caricature) is attached (wrapped) to the face/head of the avatar by the AR-Book application and displayed to user.

FIG. 14 (a and b) shows a thirteenth perspective view of the AR-Book application where the AR-Book application displays the text to ask the users if they want to save the selected avatar.

FIG. 15 (a and b) shows a fourteenth perspective view of the AR-Book application where the user saves the selected avatar or selects a different avatar.

FIG. 16 (a, b, and c) shows a fifteenth perspective view of the AR-Book application where the AR-Book application displays the text to ask the user to open the book and point the device to the first page and to do the same for each ensuing page at their leisure.

FIG. 17 (a and b) shows a sixteenth perspective view of the AR-Book application where the AR-Book application activates 3D graphics/video based on each page's AR digital content displaying the participants avatars into the story line as selected picture book characters for total immersion into the story line.

FIG. 18 shows the schematic summary of the invention.

### DETAILED DESCRIPTION OF PREFERRED EMBODIMENTS

The present invention immerses readers into the story line of a picture book by virtually transporting them as one of the characters in the picture book for a total immersion experience. The book could be papers combined or in the form of a paper or a simple card with pictures in it. When the user reads the book, he/she scans the page, image or picture through the application. This is viewed in a camera view of a device where a short video or 3D animated character appears out of the book giving an illusion to the user that the character popped out of the book performing a scene of the story line.

The present invention has (a) a scanner to scan a graphics pattern to activate and use the picture book application, using commercially available devices (smart phone, tablet, PC, laptop); (b) a user input control means to use a device (smart phone, tablet, PC, laptop) to take a picture of participants' faces, either select a caricature of the participants' faces or use actual faces of participants and select an avatar to use with participants' faces or caricatures of participants' faces and to interact with the AR-Book application; (c) a computer coupled to the scanner and responsive to the user input control means and operatively programmed to generate 3D graphics or a video that immerses participants into the picture book story line; and (d) an interface controlled by the computer and arranged to display the video and/or graphics in response to the participants' picture book and the computer.

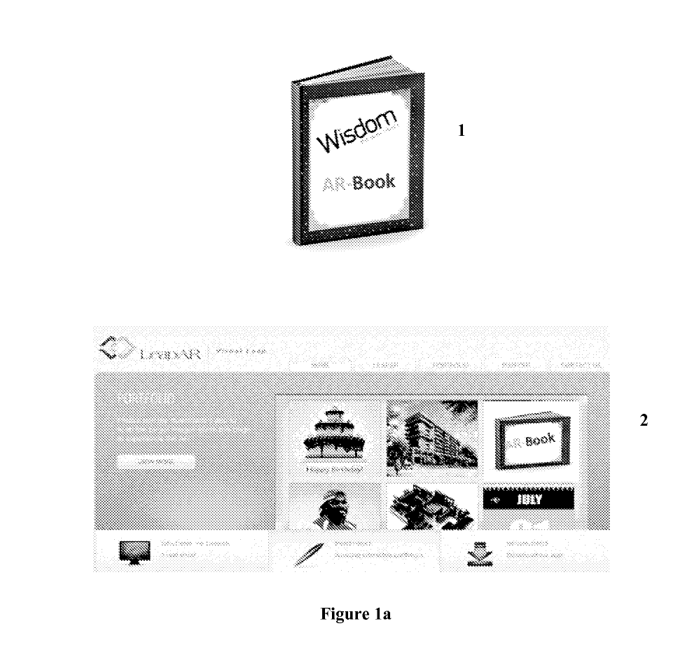

FIG. 1a shows a perspective view of the picture book, which is either actual 1 or within a website 2. The book can also be a simple card printed or an artwork or a photograph on any print material 1. The smart device scans 4 the book 1 or the representative website book 2 to activate the AR-Book application.

As seen in FIG. 1b the user 3 of the device readies the device to the picture mode to readily scan 4 the cover of the picture book 1, 2 to activate the AR-Book application and uses the AR-Book application scan process to progress through the pages of the picture book.

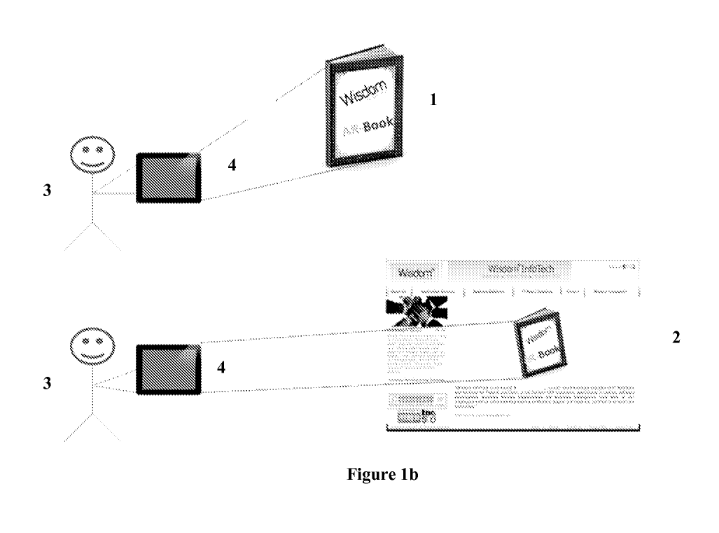

FIG. 2 (a and b) shows another perspective view of the AR-Book application welcoming a user 3. It shows screen examples for smart-phone 5 or tablet 6.

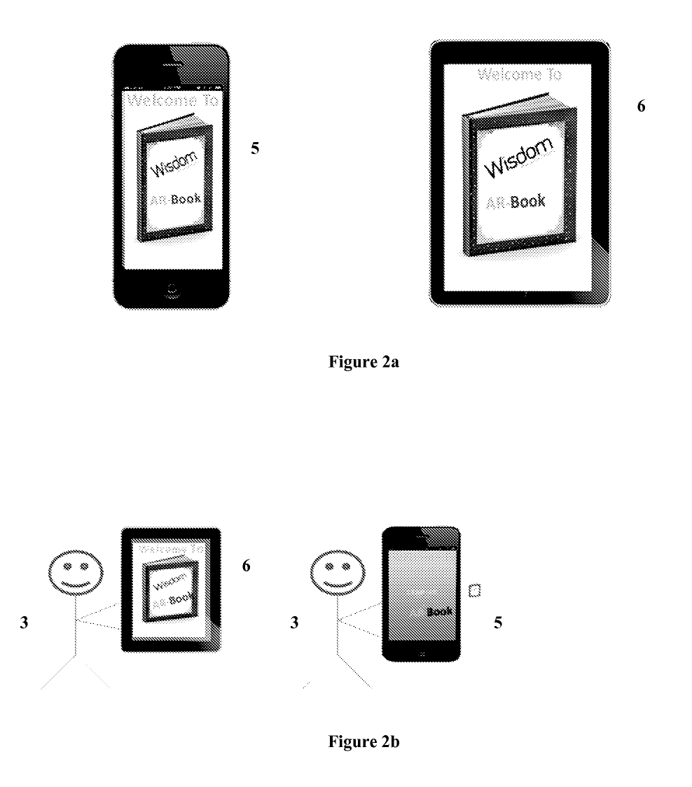

FIG. 3 (a and b) show a second perspective view of the AR-Book application for entering text for each participant's name. An example for tablet is shown (all devices work the same way) (FIG. 3a). The AR-Book application displays a welcome screen on the device and asks the user 3 to enter 9 first name texts for the participants. The user 3 enters the text of each participant's first name 10, which is saved by the AR-Book application database 12 (FIG. 3b).

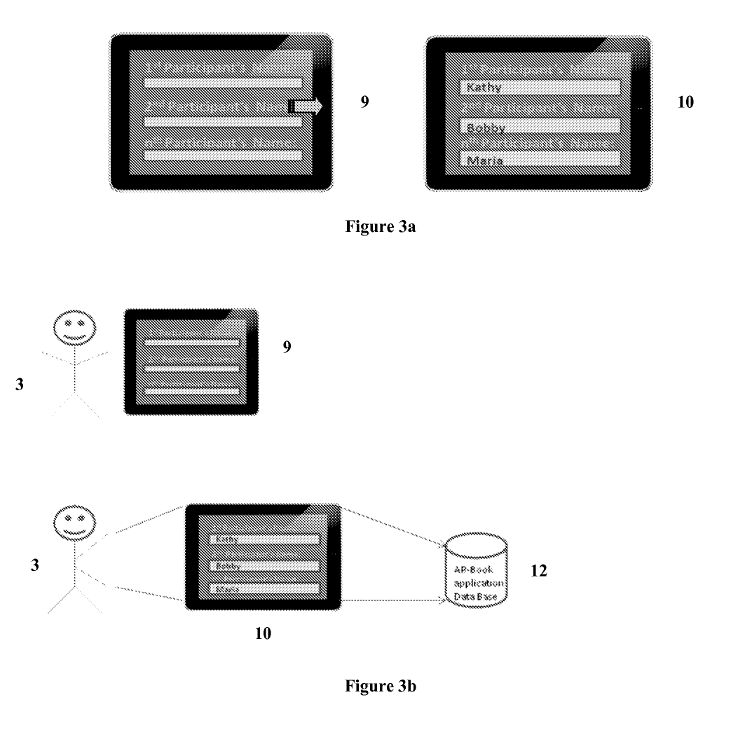

FIG. 4 (a and b) shows a third perspective view of the AR-Book application displaying the face silhouette 14. The AR-Book application database 12 displays a participant's name and a silhouette of a face 14 and asks the user 3 to put their face into the silhouette to take a picture or upload their face (FIG. 4b).

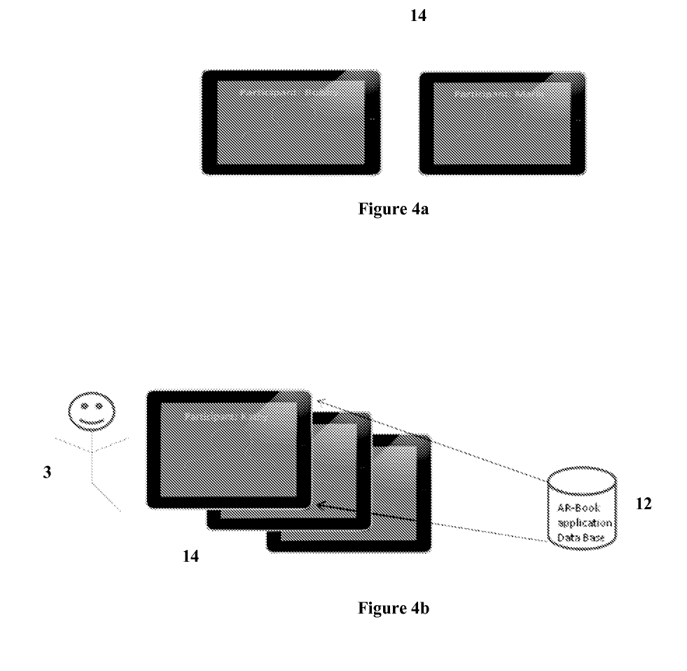

FIG. 5 (a and b) shows a fourth perspective view of the AR-Book application displaying the participant's face individually into the silhouette 15. Here, the user 3 clicks the picture button to freeze the frame. The picture is saved into the AR-Book application database 12. This step is repeated for all participants.

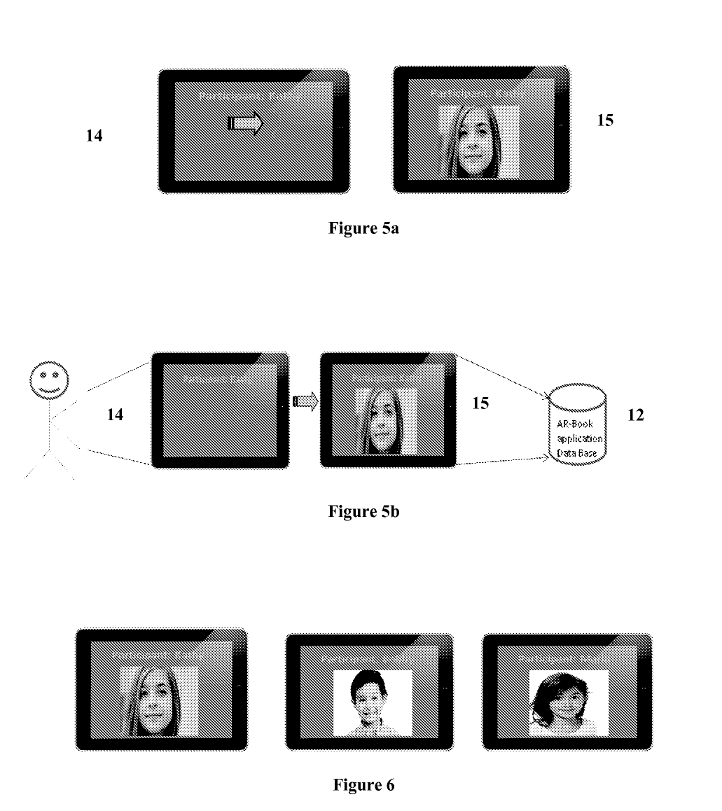

FIG. 6 shows a fifth perspective view of the AR-Book application saving a participant's face into the AR-Book application database 12. The process loops back to the step of displaying a participant's name and a silhouette of a face 14 and asking the user 3 to put their face into the silhouette to take a picture or upload their face 15 (FIG. 4) until all participants have been completed.

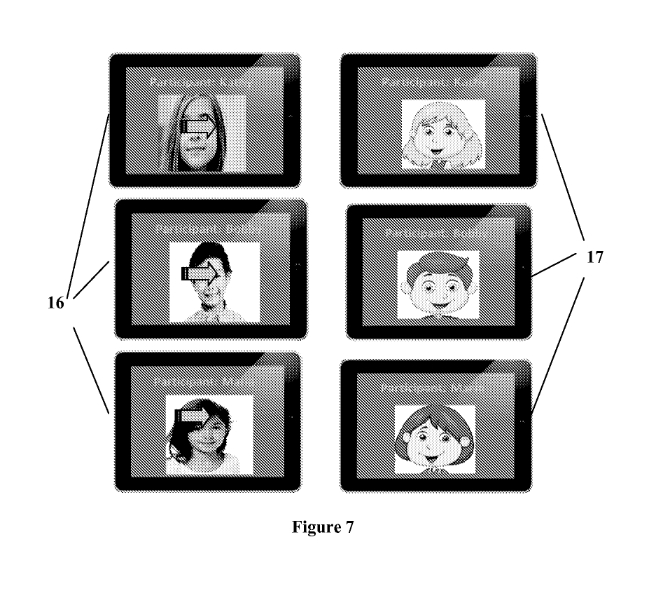

FIG. 7 shows a sixth perspective view of the AR-Book application displaying the participant's caricature face 17 onto the silhouette.

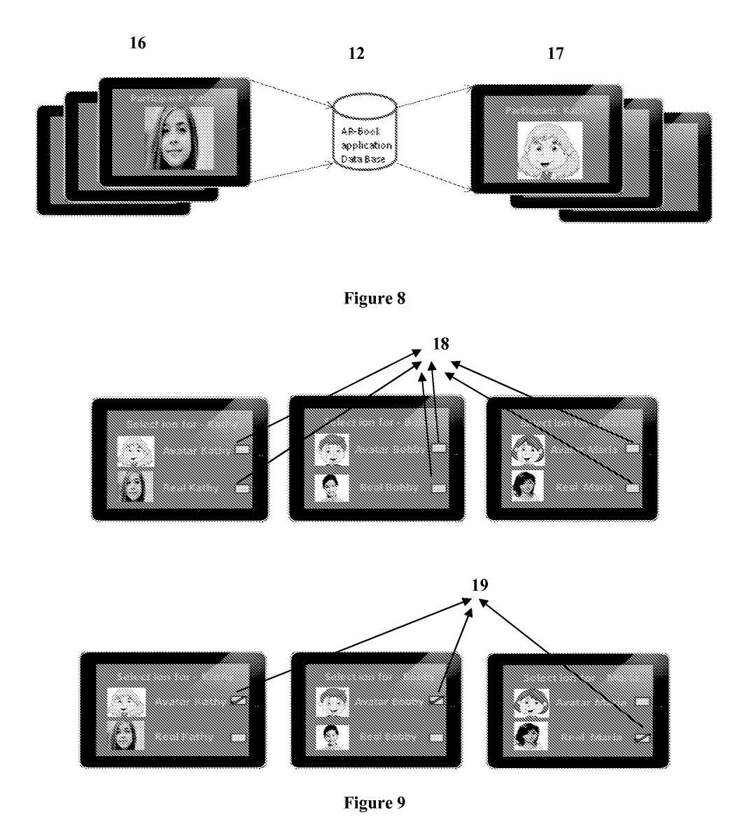

FIG. 8 shows a seventh perspective view of the AR-Book application saving the participant's caricature face 17 or their real face 16 in the form of a 3D or a 2D into the AR-Book application database 12. The process loops back to the step of displaying the participant's caricature face 17 onto the silhouette until all participants have been completed (FIG. 7).

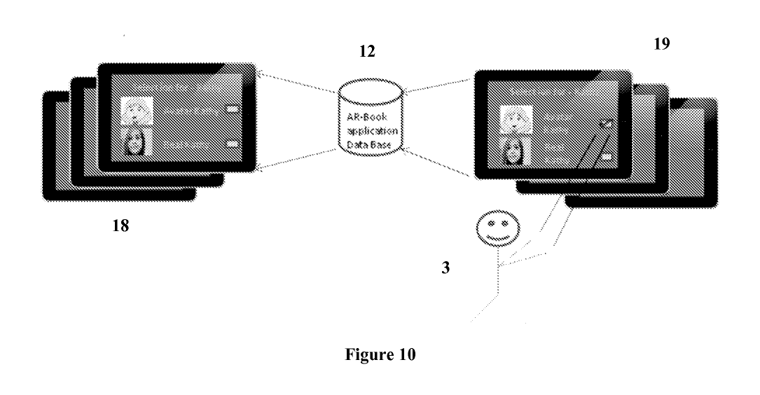

FIG. 9 shows an eighth perspective view of the AR-Book application to enter text 18 for the user by selecting 19 either the participant's caricature face or the participant's real face.

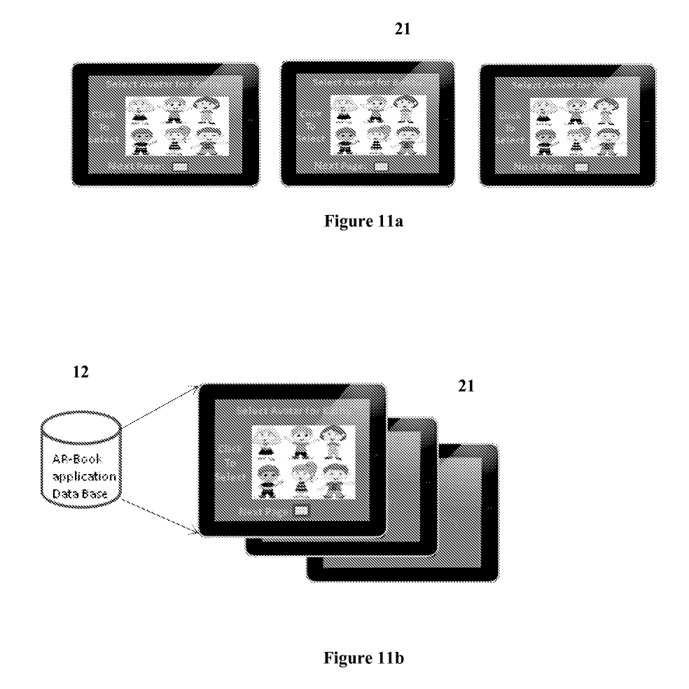

FIG. 10 shows a ninth perspective view of the AR-Book application where the user can select the desired selections for each participant. The AR-Book application displays a participant's name and a caricature of a participant's face and asks the user 3 if they want to use the actual participant's face or a caricature of the participant's face 18. A selection is made 19 and saved into the AR-Book application database 12. This step is repeated for all participants.

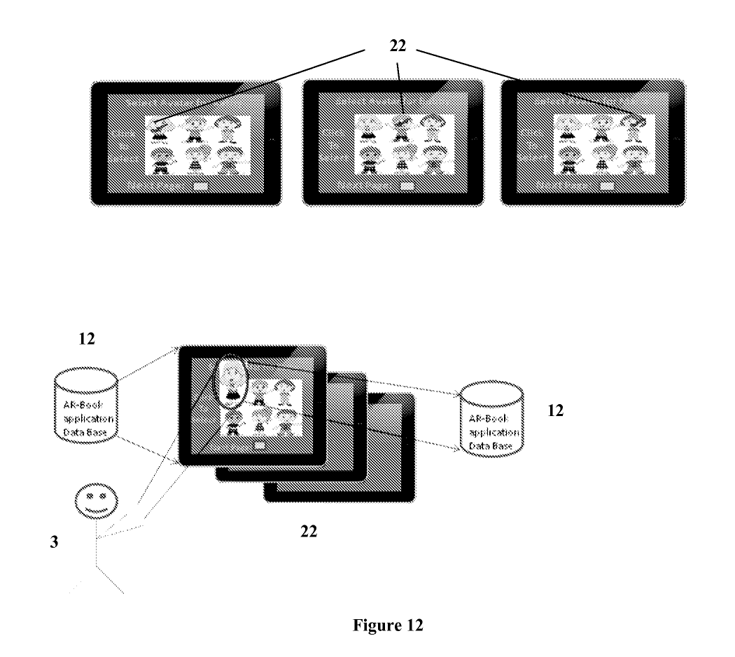

FIG. 11 (a and b) shows a tenth perspective view of the AR-Book application displaying avatars 21 for the user 3 to select an avatar for each participant. There are multiple pages of avatars to select from. The AR-Book application displays avatars of characters in the picture book and asks the user 3 to select an avatar for each participant's real 16 or caricature face 17 that has been previously selected and saved by the AR-Book application database 12.

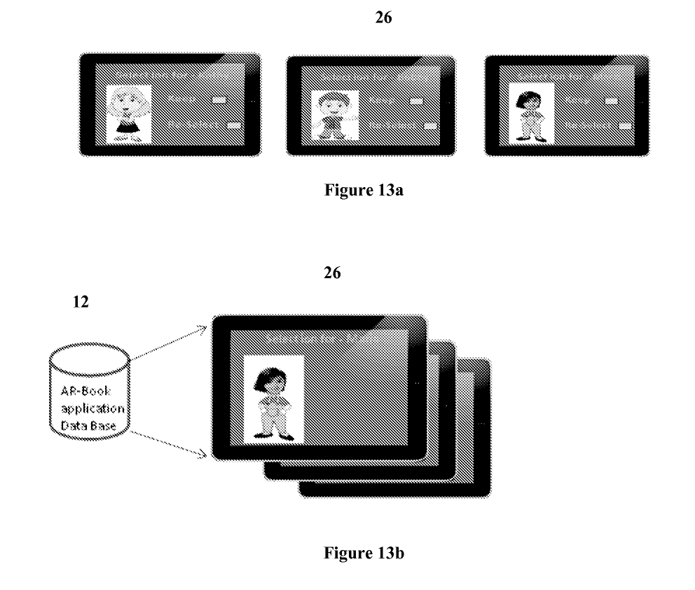

FIG. 12 shows an eleventh perspective view of the AR-Book application 12, which allows the user 3 to select the desired avatar 22 for each participant, which is saved by the AR-Book application 12.

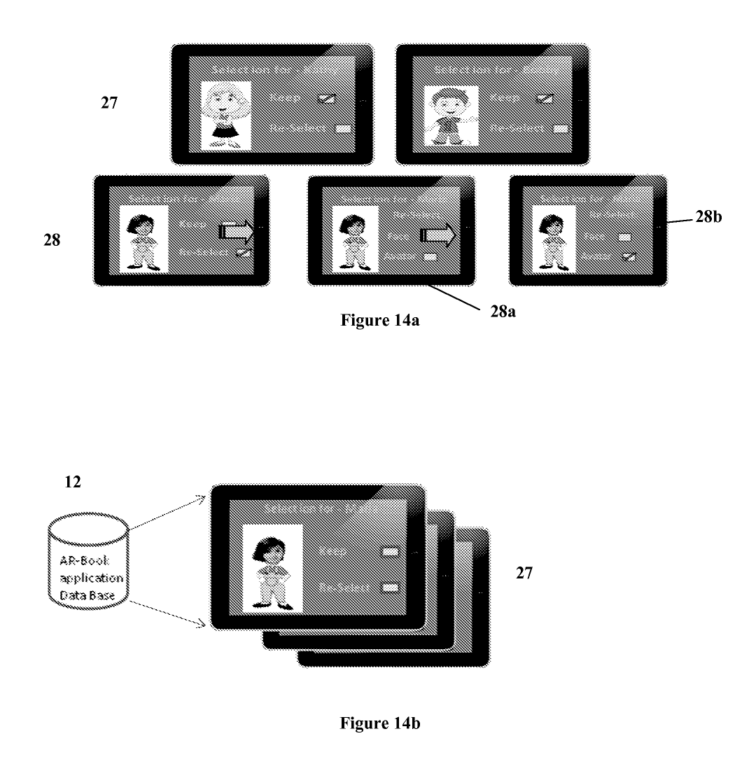

FIG. 13 shows a twelfth perspective view of the AR-Book application 12 where the participant's face (either real or caricature) is attached to the head of the avatar by the AR-Book application and displayed to user 26. The user 3 selects the desired avatars and the AR-Book application 12 displays the selected avatars 26 with the participant's real face or caricature face attached to the head of the avatar, one by one, for each participant.

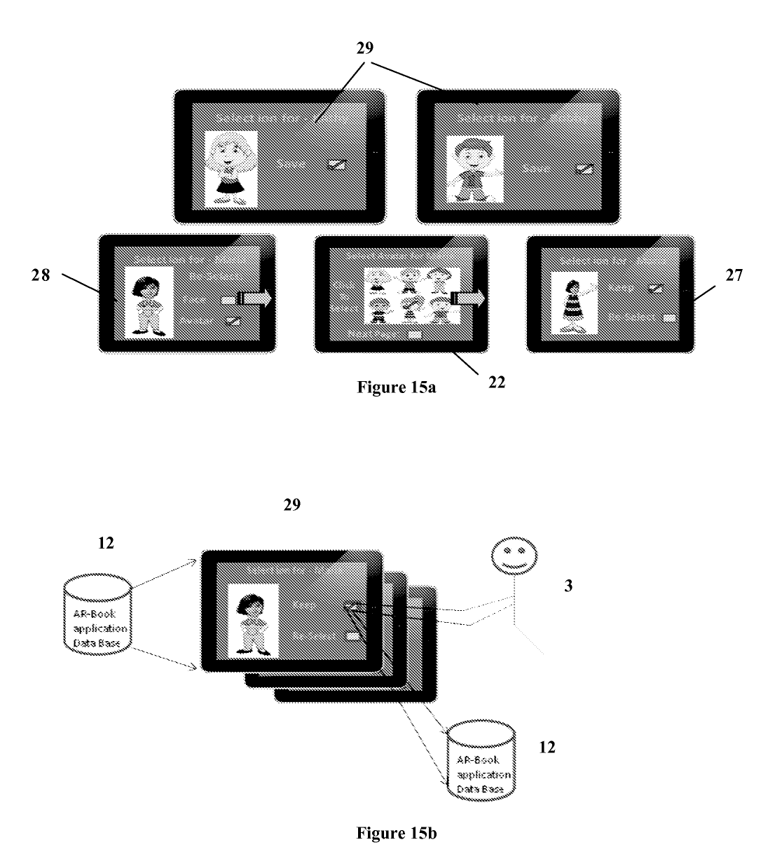

FIG. 14 (a and b) shows a thirteenth perspective view of the AR-Book application 12 displaying the text to ask the user 3 if they want to keep the selected avatar 27 or re-select the face 28a (goes back to the step of displaying the participants face individually into the silhouette 15, as shown in FIG. 5) or re-select the avatar 28b (goes back to the step of allowing the user 3 to select the desired avatar 22 for each participant, as seen in FIG. 12). The AR-Book application 12 asks the users 3 if they want to save the selected avatars 26 for each participant.

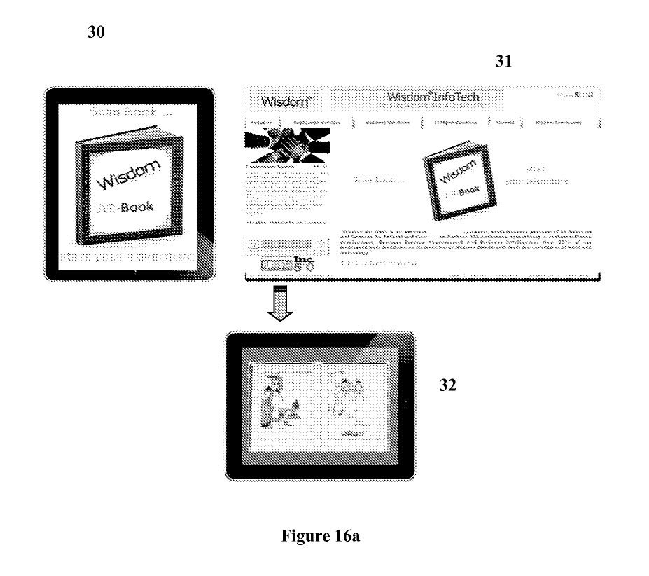

FIG. 15 (a and b) shows a fourteenth perspective view of the AR-Book application 12, which allows the user 3 to select and save the selected avatar 29 or select a different avatar 28, 22, 27. The process repeats the steps of displaying avatars 21 for the user 3 to select an avatar for each participant (FIG. 11), allowing the user 3 to select the desired avatar 22 for each participant (FIG. 12), attaching participant's face (either real or caricature) to the head of the avatar and displaying 26 (FIG. 13), displaying the text to ask the users 3 if the they want to keep the selected avatar 27 or re-select the face 28a (FIG. 14), allowing the user to select and save the selected avatar 29 or select a different avatar 28, 22, 27 (FIG. 15) until an avatar for each participant is accepted and saved by the user.

The user, therefore, can either save the selected avatars or select different avatars, which will repeat the avatar selection process until all avatars have been accepted by the user.

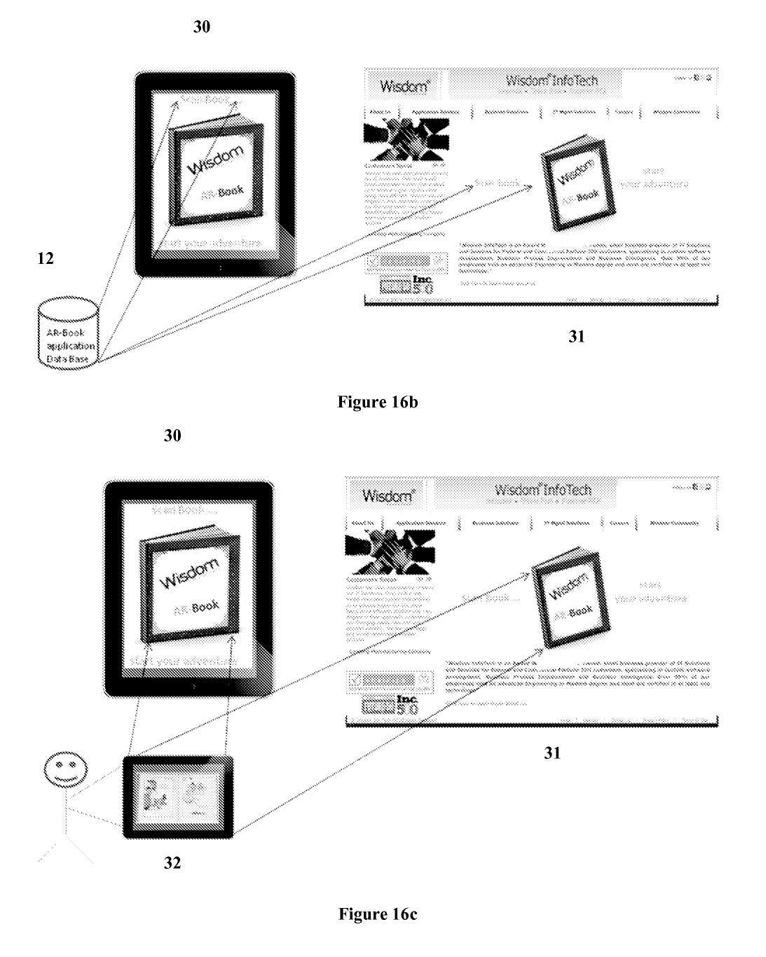

FIG. 16 (a, b and c) shows a fifteenth perspective view of the AR-Book application displaying the text to ask the user 3 to open the book 30, 31 and point the device to the first page and each ensuing page at their leisure 32.

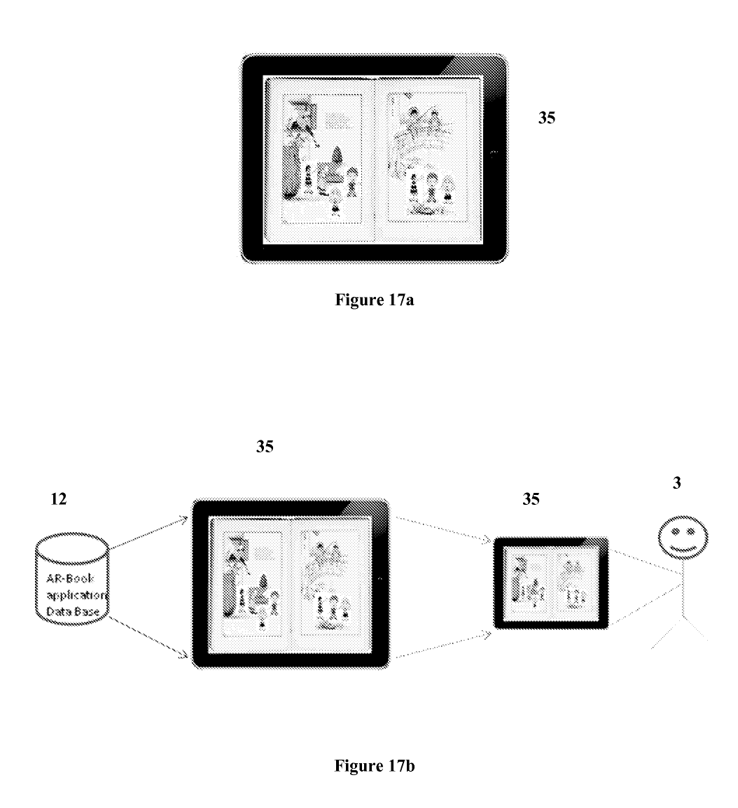

FIG. 17 is a sixteenth perspective view of the AR-Book application activating a video, 2D or a 3D graphics 35 based on each page's content. The AR-Book application 12 activates a 3D graphic or video 35 based on each page's content, from the first page until the last page, displaying the participant's avatars into the story line of each page for total immersion into the story line. The video or 3D interactive animated objects appear on the page in the form of a short clip played in that page only. This applies to a respective page, which has Augmented Reality application and every page may or may not have Augmented Reality application and these pages are decided when the book is designed. When the user activates the video mode, it is supported by an audio to play in real-time and the user interactions including hand, facial and eye movements are interactive with the audio.

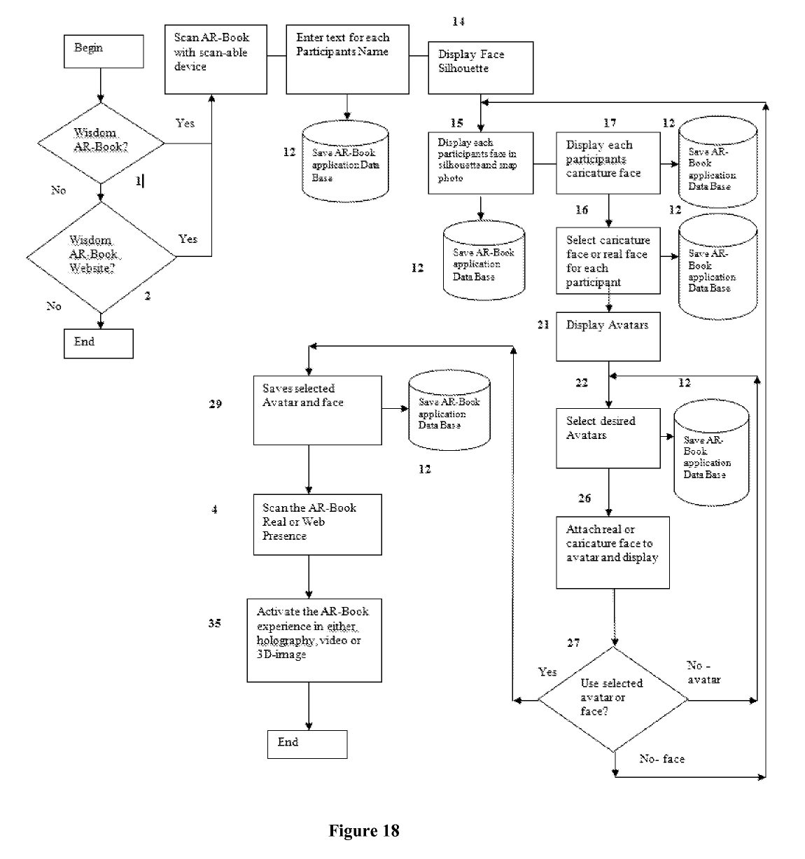

FIG. 18 describes the summary of the invention in a schematic format. The user is asked if he/she is using a wisdom AR book 1, or a wisdom AR book website 2. If yes, the AR book is scanned using a scan-able device 4. Then the participant is asked to enter his/her name in the text format 9, which is then stored in the AR book application data base 12. The face silhouettes are displayed 14. Further, the participant's face is displayed in the silhouette and in snap photo format 15, which is saved in the AR book application data base 12. Each participant's caricature face is displayed 17 and saved in the AR book application database 12. Later, the participant's caricature face, or real face, is selected 16 and saved in the AR book application data base 12. The avatars are then displayed 21 and the desired avatar is selected 22, which is saved in the AR book application data base 12. The real or caricature face is attached to the avatar and displayed 26. The user is further asked to select an avatar or face 27. Then the selected avatar or face is saved 29, which is further saved in the AR book application database 12. The AR book real or the web presence is scanned 4. Finally, the AR book experience in either holography, video or 3D image form is activated 35. In case where there is no avatar, the user is asked to select the desired avatars 22. If there is no face, the participant's face is again displayed in the silhouette and snap photo format 15.

The AR-Book augmented reality application invention also can include prior art and technology that is available on commercial smart devices (smart phone, tablet, Kindle, Nuke, MAC, PC, laptop). The invention also can include art and technology used for 3D graphics and video.

In future embodiments, we envision the user being able to incorporate the following features:
Add more coded picture books to expand use of the invention.
Continuously improve the vibrancy of the videos, graphics and avatars.
Expand the number of available avatars from which to choose.
Incorporate options for Google Glass, Moverio BT-200 and similar glasses technology.
Expand for Hologram technology

The foregoing detailed description of the preferred embodiments and the appended figures have been presented only for illustrative and descriptive purposes and are not intended to be exhaustive or to limit the scope and spirit of the invention. The embodiments were selected and described to best explain the principles of the invention and its practical applications. One of ordinary skill in the art will recognize that many variations can be made to the invention disclosed in this specification without departing from the scope and spirit of the invention.

1. A picture book augmented reality (AR) application to immerse one or more participants into a story line while viewing an actual physical AR-Book, a picture book, a picture book via AR application wherein one or more pictures come alive in the form of a video, 3-Dimensional (3D) figure displayed on top of the picture and the participant's own image become part of the story along with the one or more story line characters while displaying the AR content, having (a) a scanner, (b) an input device, (c) a computer, and (d) an interface, wherein:
a) the scanner scans a graphics pattern using at least one smart device to activate and use the picture book application;
b) the input device uses the at least one smart device to take the picture of the participant's face, select a caricature of the participant's face, use the actual face of the participant, and selects an avatar to use with the participants face, caricature of the participant's face and to interact with the AR-Book application;
c) the computer generates the 3D graphics and a video that immerses one or more participants into the picture book story line; and
d) the interface displays the 3D graphics and the video in response to the participant picture book and the computer.

2. The picture book augmented reality application to immerse one or more participants into the story line of claim 1, wherein the picture book comprises an actual picture book (1) and a website picture book (2) and a user (3) alerts the at least one smart device to the picture mode to readily scan (4) a cover of the actual picture book (1), the website picture book (2) to activate the AR-Book application.

3. The picture book augmented reality application to immerse one or more participants into the story line of claim 1, wherein the smart device includes a smart-phone (5) and a tablet (6).

4. The picture book augmented reality application to immerse one or more participants into the story line of claim 1, wherein a welcome screen is displayed on the smart device and asks the user (3) to enter (9) first name text for the participant such that the user (3) enters the text of each participant's first name (10), which is saved by an AR-Book application database (12).

5. The picture book augmented reality application to immerse one or more participants into the story line of claim 4, wherein a face silhouette (14) is displayed by the AR-Book application database (12) and asks the user (3) to put the face into the silhouette to take a picture or upload the face.

6. The picture book augmented reality application to immerse one or more participants into the story line of claim 5, wherein the user (3) clicks a picture button to freeze a frame such that the picture is saved into the AR-Book application database (12) and displays one or more participants face individually into a silhouette (15).

7. The picture book augmented reality application to immerse one or more participants into the story line of claim 4, wherein the participant's caricature face (17) and a real face (16) are stored in the form of the 3D or 2D into the AR-Book application database (12).

8. The picture book augmented reality application to immerse one or more participants into the story line of claim 4, wherein the user (3) enters a text (18) by selecting (19) the participant's caricature face (17) and the participant's real face (16).

9. The picture book augmented reality application to immerse one or more participants into the story line of claim 4, wherein the user (3) selects an avatar for each participant from a display of one or more avatars (21) of one or more characters in the picture book for each participant's real (16) and the caricature face (17) that has been previously selected and saved by the AR-Book application database (12) and selects an desired avatar (22).

10. The picture book augmented reality application to immerse one or more participants into the story line of claim 1, wherein the participant's real face (16) and the caricature face (17) is attached to a head of the avatar and displayed (26) to the user (3).

11. The picture book augmented reality application to immerse one or more participants into the story line of claim 1, wherein the user selects an avatar (27) or re-select the face (28a) or re-select the avatar (28b) and saves the selected one or more avatars (26) for each participant.

12. The picture book augmented reality application to immerse one or more participants into the story line of claim 1, wherein the user (3) selects and saves a selected avatar (29) or selects a different avatar (28, 22, 27) until an avatar for each participant is accepted and saved.

13. The picture book augmented reality application to immerse one or more participants into the story line of claim 1, wherein the user (3) opens a book (30, 31) and point the device to the first page and each ensuing page at leisure (32).

14. The picture book augmented reality application to immerse one or more participants into the story line of claim 13, wherein a video, a, a 2D or a 3D graphics (35) is activated based on content of each page and displays the participant's one or more avatars into the story line of each page for total immersion into the story line.

15. The picture book augmented reality application to immerse one or more participants into the story line of claim 1, wherein the video is supported by an audio to play in real-time and one or more user interactions including hand, facial and eye movements are interactive with the audio.

16. The picture book augmented reality application to immerse one or more participants into the story line of claim 1, wherein the user handles the AR book in one or more languages.

17. The picture book augmented reality application to immerse one or more participants into the story line of claim 1, wherein the application works with holographic technology.

18. The picture book augmented reality application to immerse one or more participants into the story line of claim 1, wherein the application works with viewing devices including Google Glass and Moverio BT-200.

19. An augmented reality (AR) application to immerse one or more participants into a story line while viewing an image, wherein at least one picture on the image comes alive in the form of a video, 3-Dimensional (3D) figure displayed on top of the picture and the participant's own image becomes part of the story along with the one or more story line characters while displaying the AR content, having (a) a scanner, (b) an input device, (c) a computer, and (d) an interface, wherein:
a) the scanner scans a graphics pattern using at least one smart device to activate and use the application;
b) the input device uses the at least one smart device to take the picture of the participant's face, select a caricature of the participant's face, use the actual face of the participant, and selects an avatar to use with the participants face, caricature of the participant's face and to interact with the application;
c) the computer generates the 3D graphics and a video that immerses one or more participants into the story line; and
d) the interface displays the 3D graphics and the video in response to the image and the computer.
